(19) United States
(12) Patent Application Publication
(10) Pub. No.: US 2014/0217120 A1
(43) Pub. Date: Aug. 7, 2014

(54) MULTI-FUNCTIONAL AND MULTI-PURPOSE AIR FRESHENER AND CLEANER

(71) Applicant: Ian BERRY, Tampa, FL (US)

(72) Inventor: Ian BERRY, Tampa, FL (US)

(73) Assignee: EDWARD ARTHUR INTERNATIONAL LLC, Charlestown, Nevis (KN)

(21) Appl. No.: 14/172,367

(22) Filed: Feb. 4, 2014

Related U.S. Application Data
(60) Provisional application No. 61/760,411, filed on Feb. 4, 2013.

(51) Int. Cl. B67D 7/70; B67D 7/06

(52) U.S. Cl. CPC B05B 11/0078
USPC 222/136; 222/144.5

(57) ABSTRACT

A multi-compartmented dispensing system for dispensing fluids from multiple compartments of a single container is provided. The container comprises a main housing having multiple reservoirs, each configured to store a different fluid. The dispensing system further includes a spray head, which is removably coupled to the main housing, and includes a pump and a nozzle in a fluid flow path. The spray head is switched between each of the reservoirs to allow a user to select one of the reservoirs, and dispense a fluid from the selected reservoir.

### CROSS-REFERENCE TO RELATED APPLICATIONS

This application claims priority from U.S. Provisional Application No. 61/760,411 filed on Feb. 4, 2013 in the U.S. Patent and Trademark Office, the disclosure of which is incorporated herein by reference in its entirety.

### BACKGROUND

1. Field

The exemplary embodiments generally relate to a multi-compartmented dispensing system which stores air fresheners and/or household cleaning products, disinfectants etc., in multiple receptacles of a single container, for use in the containment and administration of multiple scents and/or formulations/fluids. The formulations and/or fluids may be used on different surfaces such as glass, hardwood, tile etc.

2. Description of the Related Art

Generally, household cleaning or air freshener containers are built in order to contain a single substance. This is done in order to prevent cross contamination or improper blending of the contained substances. Accordingly, if a user wants to apply different cleaning substances during a cleaning process, multiple containers would have to be bought and utilized, therefore resulting in user inconvenience and increased cost. Similarly, if a user wants to experience different air freshener scents, the user would have to purchase multiple bottles, therefore resulting in increased cost and inconvenience.

Accordingly, there is a need for a single container which incorporates multiple compartments, in order to allow a user to easily, conveniently, and interchangeably switch between multiple fluids.

### SUMMARY

The present disclosure has been developed in order to overcome the above drawbacks and other problems associated with the related art arrangement. An aspect of the present disclosure provides a multi-compartmentalized container which retains multiple different liquids.

According to an exemplary embodiment of the application, there is provided a multi-compartmentalized air freshener or household cleaning container comprising a main housing; a first reservoir configured to retain a first substance; a second reservoir configured to retain a second substance, and a rotatable spray head which switches from the first reservoir to the second reservoir, wherein the first reservoir and the second reservoir are contained within the main housing.

According to another aspect of the exemplary embodiments, a multi-compartment container comprises a main housing; a first reservoir contained within the main housing and configured to retain a first substance; a second reservoir contained within the main housing and configured to retain a second substance; and a spray head comprising a first spray actuator which is operable to expel a fluid from one of the first reservoir and the second reservoir when actuated, and a second spray actuator which is operable to expel a fluid from the other of the first reservoir and the second reservoir when actuated.

According to an aspect of the exemplary embodiment, the first reservoir and the second reservoir are separated by a barrier within the main housing.

According to another aspect of the exemplary embodiment, a diameter of a lower portion of the main housing is greater than a diameter of an upper portion of the main housing.

According to another exemplary embodiment, a multi-compartment container comprises a main housing, a first reservoir contained within the main housing and configured to retain a first liquid, a second reservoir contained within the main housing and configured to retain a second liquid, a first trigger, which is configured to expel the first liquid from the first reservoir when actuated, and a second trigger which is configured to expel the second liquid from the second reservoir when actuated.

These and other objects of the exemplary embodiments, as well as many of the intended advantages thereof, will become more readily apparent when reference is made to the following description, taken in conjunction with the accompanying drawings.

### BRIEF DESCRIPTION OF THE DRAWINGS

These and/or other aspects of the present disclosure will become apparent and more readily appreciated from the following description of the exemplary embodiments, taken in conjunction with the accompanying drawings of which:

FIG. 1 is a front perspective view illustrating a structure of the multi-functional and multi-purpose air freshener and cleaner container according to an exemplary embodiment.

FIG. 2 is a view illustrating a structure of the multi-functional and multi-purpose air freshener and cleaner container according to another exemplary embodiment.

FIG. 3 is a view illustrating a structure of the multi-functional and multi-purpose air freshener and cleaner container according to another exemplary embodiment.

FIG. 4 is an aerial view of the compartmentalized multi-functional and multi-purpose air freshener and cleaner container according to another exemplary embodiment.

### DETAILED DESCRIPTION OF THE EXEMPLARY EMBODIMENTS

Hereinafter, certain exemplary embodiments of the present disclosure will be described in detail with reference to the accompanying drawings.

The matters defined herein, such as a detailed construction and elements thereof, are provided to assist in a comprehensive understanding of this description. Thus, it is apparent that the exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased to assist in a comprehensive understanding of the device.

Exemplary embodiments of the present disclosure provide a multi-compartmented dispensing system which stores air fresheners and/or household cleaning products, disinfectants etc., in multiple receptacles of a single container, for use in the containment and administration of multiple scents and/or formulations/fluids. The formulations and/or fluids may be used on different surfaces such as glass, hardwood, tile etc.

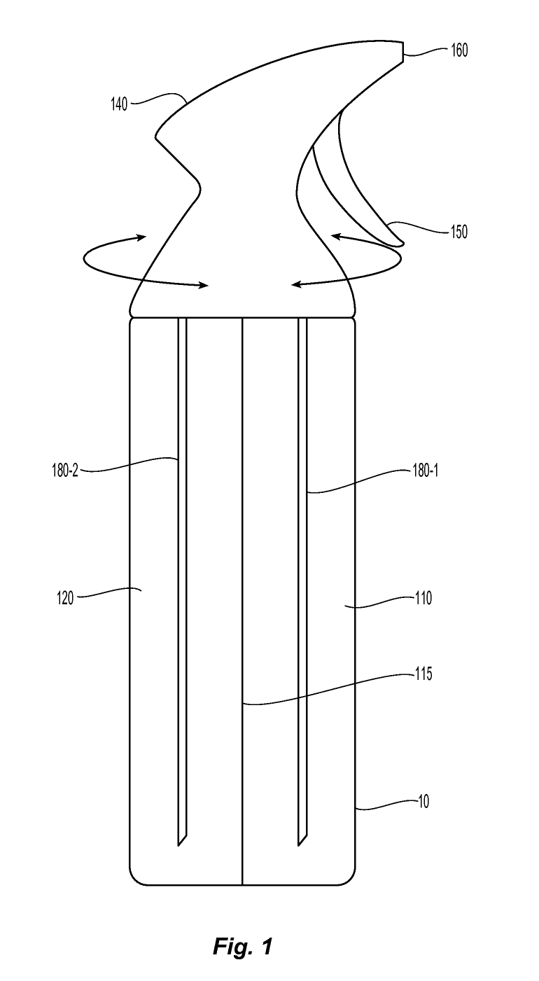

FIG. 1 illustrates a view of the multi-functional and multi-purpose air freshener and cleaner container 100 according to an exemplary embodiment. The container 100 comprises a main housing 10 which comprises a first reservoir 110 and a second reservoir 120. However, the number of reservoirs of the multi-functional and multi-purpose air freshener and cleaner container 100 is not limited thereto. The receptacle may be compartmentalized into three or more reservoirs.

The main housing 10 may include at least one pumping mechanism (not shown), and a spray head 140 coupled to the pumping mechanism in a fluid flow path. The spray head 140 is rotatably coupled to the main housing 10. The main housing 10 is configured to hold different types of material, such as, but not limited to, air fresheners, perfumes, cleaning products, detergents, water, and disinfectant. Each of the first reservoir 110 and the second reservoir 120 includes a hose (180-1 or 180-2) which is coupled to the pumping mechanism, and allows the dispensing of the fluid from each reservoir when a spray actuator 150 is activated by a user.

The spray head 140 includes the spray actuator 150 and a nozzle 160. A user switches from the first reservoir 110 to the second reservoir 120 and vice versa, in order to obtain access to the fluids in each reservoir. If the user wishes to access reservoir 110, the spray head 140 is turned in a first direction to disconnect the hose 180-2 in reservoir 120 from the pumping mechanism, and connect hose 180-1 to the pumping mechanism.

Similarly, if the user wishes to access reservoir 120, the spray head 140 is turned in a second direction (opposite to the first direction) to disconnect hose 180-1 from the pumping mechanism, and connect hose 180-2 in reservoir 120 to the pumping mechanism.

The rotatable head 140 therefore allows the user to switch from a first fragrance, cleaner, disinfectant, etc. stored in the first reservoir 110 to a second fragrance, cleaner, disinfectant, etc. stored in the second reservoir 120.

The spray actuator 150 is movable relative to the main housing 10 to dispense fluid through the nozzle 160. More specifically, the actuator 150 is movable between an extended position and a retracted position relative to the main housing 10. Upon the spray actuator 150 being activated by a user, the fluid in a selected reservoir is transferred through a hose (180-1 or 180-2) in the selected reservoir, and expelled through the nozzle 160. In an exemplary embodiment, the actuator 150 is biased to the extended position by way of a spring or other biasing mechanism.

The first reservoir 110 and the second reservoir 120 are completely separated from each other by a barrier 115, in order to prevent the fluids within each compartment or reservoir from mixing with each other. Accordingly a user may purchase an air freshener with multiple fragrances contained within a single housing, separated into compartments, and have access to each fragrance by rotating the spray head to the compartment that contains the users' fragrance of choice.

Similarly, the user may purchase cleaners or disinfectants with multiple formulas contained within a single main housing, separated by compartments, and have access to each compartment by rotating the spray head to the compartment that contains the users' cleaner or disinfectant of choice.

The nozzle 160 is configured to emit a stream or nebulized spray. However, the exemplary embodiment is not limited thereto, and the nozzle 160 may be configured to emit different types of sprays such as mist.

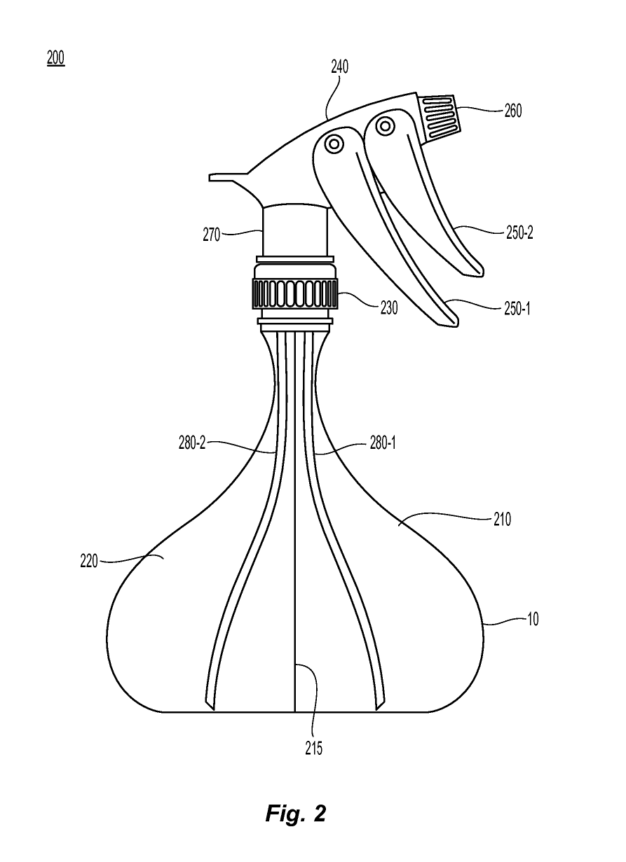

FIG. 2 illustrates a perspective view of the multi-functional and multi-purpose air freshener and cleaner container 200 according to an exemplary embodiment. The container 200 comprises a main housing 10 which includes a first reservoir 210 and a second reservoir 220, each of which is configured to store different fluids.

The main housing 10 may have a tapered shape, with a lower portion of the main housing being of a substantially larger diameter that an upper portion of the main housing.

A spray head 240 includes a first spray actuator 250-1, a second spray actuator 250-2, a nozzle 260 and a rotatable knob 270.

The first spray actuator 250-1 and the second spray actuator 250-2 may be located adjacent to each other on a neck portion of the spray head. However, the location of the first spray actuator 250-1 and the second spray actuator 250-2 is not limited thereto, and the individual actuators may be attached to different portions of the spray head.

The first spray actuator 250-1 may be connected to a first hose 280-1 which is housed in the first reservoir 210. The second spray actuator 250-2 may be connected to a second hose 280-2, which is housed in the second reservoir 220. The actuation of the first spray actuator 250-1 and the optional actuation of a second spray actuator 250-2 allows a user to switch from the first reservoir 210 to the second reservoir 220 and vice versa. The independent actuation of the separate spray actuators therefore allows the user to switch from a first fragrance, cleaner, disinfectant, etc. stored in the first reservoir 210 to a second fragrance, cleaner, disinfectant, etc. stored in the second reservoir 220.

According to another exemplary embodiment, the first spray actuator 250-1 and the second spray actuator 250-2 may be a pressurized trigger or lever which is coupled to the compartment containing the fragrance of the users' choice, or containing the cleaner or disinfectant of the users' choice.

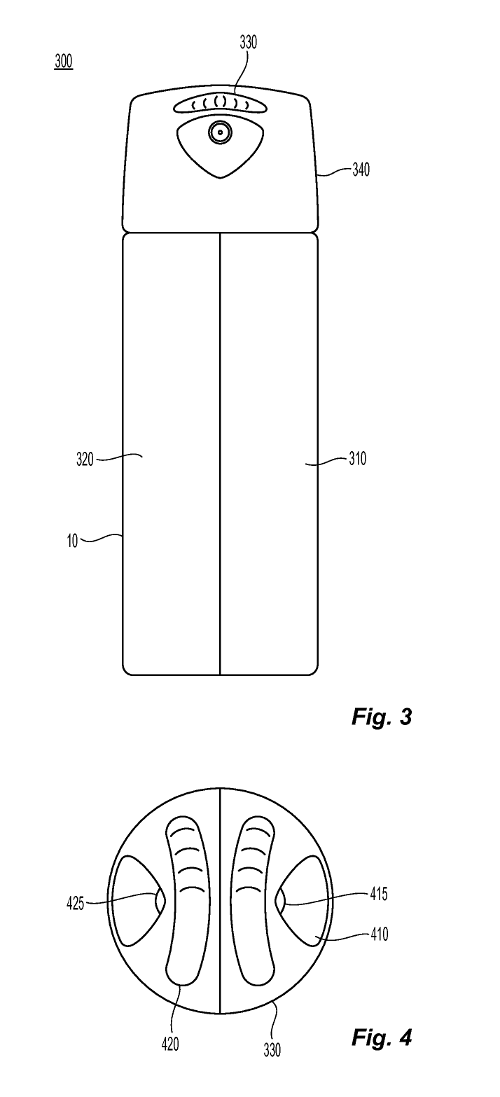

FIGS. 3 and 4 illustrate the multi-functional and multi-purpose air freshener and cleaner container according to another exemplary embodiment. FIG. 3 illustrates a perspective view of the multi-functional and multi-purpose air freshener and cleaner container 300 according to an exemplary embodiment. The container 300 comprises a main housing 10 which includes a first reservoir 310 and a second reservoir 320, each of which is configured to store different fluids. Although the main housing 10 is shown as being substantially circular in the current exemplary embodiment, the shape of the housing is not so limited, and the main housing may be embodied in different shapes, for example, rectangular.

Additionally, although the exemplary embodiment illustrates two reservoirs, the exemplary embodiment is not so limited. The main housing may comprise three or more reservoirs.

In the contemplated exemplary embodiment, a spray head 340 comprises a trigger assembly 330 which includes a first trigger portion 410 (FIG. 4), which is connected to a first reservoir 310, and a second trigger portion 420 which is connected to a second reservoir 320.

The first trigger portion 410 includes a nozzle 415 through which a fluid is emitted when the trigger portion 410 is actuated. Trigger portion 420 includes a nozzle 425 through which a fluid is emitted when the trigger portion 420 is actuated.

The trigger portions 410 and 420 are movable relative to the main housing 10 to dispense fluid from the nozzles 415 and 425, respectively. The trigger portions 410 and 420 are movable between an extended position and a retracted position. As the trigger portions 410 and 420 move from the extended position to the retracted position, fluid is dispensed from a selected reservoir of the compartmentalized container 300.

FIG. 4 illustrates an aerial or top view of the trigger assembly 330. The user may have access to a first reservoir 310 by depressing the trigger portion 410 and dispense the fluid in reservoir 310. Similarly, the user may have access to a second reservoir 320 by depressing the trigger 420 and dispense the fluid in reservoir 320.

While the exemplary embodiments of the present disclosure have been described, additional variations and modifications of the exemplary embodiments may occur to those skilled in the art once they learn of the basic inventive concepts. Therefore, it is intended that the appended claims shall be construed to include both the above exemplary embodiments and all such variations and modifications that fall within the spirit and scope of the inventive concepts.

What is claimed is:

1. A multi-compartment container comprising:
a main housing;
a first reservoir configured to retain a first substance;
a second reservoir configured to retain a second substance, and
a rotatable spray head which switches from the first reservoir to the second reservoir,
wherein the first reservoir and the second reservoir are contained within the main housing.

2. The container of claim 1, wherein the first substance is accessed by rotating the spray head to the first reservoir, and the second substance is accessed by rotating the spray head to the second reservoir.

3. The container of claim 2, wherein the spray head accesses at least one of the first reservoir and the second reservoir by disconnecting a first hose in the first reservoir and connecting a second hose in the second reservoir.

4. A multi-compartment container comprising:
a main housing;
a first reservoir contained within the main housing and configured to retain a first substance;
a second reservoir contained within the main housing and configured to retain a second substance, and
a spray head comprising a first spray actuator which is operable to expel a substance from one of the first reservoir and the second reservoir when actuated, and a second spray actuator which is operable to expel a substance from the other of the first reservoir and the second reservoir when actuated.

5. The method of claim 4, wherein the first reservoir and the second reservoir are separated by a barrier within the main housing.

6. The method of claim 4, wherein a diameter of a lower portion of the main housing is greater than a diameter of an upper portion of the main housing.

7. A multi-compartment container comprising:
a main housing;
a first reservoir contained within the main housing and configured to retain a first substance;
a second reservoir contained within the main housing and configured to retain a second substance;
a first trigger portion configured to expel the first substance from the first reservoir when actuated, and
a second trigger portion configured to expel the second substance from the second reservoir when actuated.

8. The container of claim 7, wherein the first trigger portion comprises a first nozzle and the second trigger portion comprises a second nozzle.
